(19) United States
(12) Patent Application Publication
(10) Pub. No.: US 2008/0106176 A1
(43) Pub. Date: May 8, 2008

(54) Reflector Lamp With Halogen Filling

(75) Inventors: Wolfgang Andorfer, Munchen (DE); Axel Bunk, Munchen (DE); Frank Glockler, Schemfeld (DE); Christoph Krieglmeyer, Hitzhofen/Hofstetten (DE)

Correspondence Address: OSRAM SYLVANIA INC, 100 ENDICOTT STREET, DANVERS, MA, 01923, US

(73) Assignee: Patent-Treuhand-Gesellschaft Fur Elektrische Gluhlampen MBH, Munchen (DE)

(21) Appl. No.: 11/547,636

(22) PCT Filed: Mar. 31, 2005
(86) PCT No.: PCT/DE05/00571

§ 371 Date: Oct. 5, 2006

(30) Foreign Application Priority Data
Apr. 6, 2004 (DE) 10 2004 016 954.3

(51) Int. Cl. H01K 1/22; H01K 1/50

(52) U.S. Cl. 313/113; 313/578

(57) ABSTRACT

A reflector lamp whose lamp receptacle (1) is provided in part with a reflective coating (6) as well as a reflector contour. The coating is composed of at least two layers of highly heat-resistant metals. One of the layers reflects as well as possible while the superimposed layer absorbs as well as possible.

The invention relates to a reflector lamp with a halogen filling in accordance with the precharacterizing clause of patent claim 1.

### I. PRIOR ART

The European patent specification EP 0 495 194 B1 describes a reflector lamp, comprising a reflector, which is formed, for example, by a parabolic or ellipsoidal spherical glass cap, and a halogen incandescent lamp inserted therein, which is arranged in the optical axis of the reflector.

### II. DESCRIPTION OF THE INVENTION

It is the object of the invention to provide a compact reflector lamp with a halogen filling. A further object is to specify a reflector lamp having as few components as possible and having as small dimensions as possible.

This object is achieved according to the invention by the features of patent claim 1. Particularly advantageous embodiments of the invention are described in the dependent patent claims.

The halogen incandescent lamp according to the invention has a transparent lamp vessel, which in particular is sealed at one end, as the single lamp vessel with at least one incandescent filament arranged therein. One section of the lamp vessel is in the form of a reflector and is provided with a light-reflective coating. In comparison to a conventional reflector lamp, in the case of the reflector lamp according to the invention the reflector contour is formed as part of the lamp vessel. The spherical glass cap of the conventional reflector lamp which until now has usually been used in the case of halogen incandescent lamps is no longer required, with the result that miniaturization is possible. The reflector lamp therefore requires fewer parts, is more cost-effective and has considerably smaller dimensions than the conventional reflector lamps based on halogen incandescent lamps. It can be used, for example, in downlights instead of the conventional reflector lamp. As a result, it is possible for correspondingly smaller openings to be used in the false ceiling. The dimensions of the halogen incandescent lamp according to the invention transversely with respect to its longitudinal axis are advantageously only a maximum of 30 mm, preferably even at most 20 mm.

The conventional reflector lamps preferably use aluminum as the metallic coating since this material has a high reflectance for all light wavelengths. While in the case of conventional incandescent lamps this material is also suitable for coating directly on the bulb since the large dimensions guarantee a sufficiently low thermal load, in the case of much smaller halogen incandescent lamps the situation is quite different. There is no suitable metallic material which has, at the same time, a sufficiently high reflectance and a sufficiently high thermal resistance. For this reason, until now, at best very expensive dichroitic coatings for IRC coatings for halogen incandescent lamps have been used. According to the invention, this problem is solved by the suitable combination of two metal layers. The layers need to be applied on the outside owing to the aggressive halogen filling. The first layer is reflective and preferably consists of highly thermally resistant metals such as silver and/or rhodium. On the other hand, for example, gold is less well suited. Aluminum is not suitable at all since its thermal resistance is too low, with the result that it is not possible to achieve an expediently useful life in the case of these small bulb dimensions. Since, however, the metals of the first layer which can be used according to the invention and which are sufficiently thermally resistant sometimes only have moderately good reflection properties and sometimes only have a deficient level of resistance to environmental influences, a second metallic coating is required which is applied so as to cover the first layer. This metal also needs to be highly thermally resistant and to absorb the remaining radiation which is not absorbed by the first layer. Suitable materials for this have predominantly proven to be chromium and/or nickel. In this manner, some of the radiation is again transported back into the bulb and the proportion of radiation which was transmitted into the first layer and is disruptive for the viewer and the surrounding material is eliminated. At the same time, these materials protect the sensitive first layer.

Even a coating comprising three layers is preferably used because it has proven to be expedient to protect the metallic layers from oxidation at the high operating temperatures of such lamps. Primarily suitable for this purpose is a metal oxide or metal nitride layer, primarily a silicon-containing layer, preferably consisting of SiO₂ of SiN.

Suitable layer thicknesses for the first layer are 150 to 1200 nm, preferably 400 to 800 nm. Suitable layer thicknesses for the second layer are 20 to 500 nm, preferably 50 to 250 nm. Suitable layer thicknesses for the third layer are 100 to 800 nm, preferably 400 to 700 nm.

The reflector lamp advantageously has a lamp vessel which is sealed at one end and is designed to be axially symmetrical with respect to a longitudinal axis, the at least one incandescent filament being arranged in the longitudinal axis, and that section of the lamp vessel which is in the form of the reflector being an annular section, which adjoins the sealed end of the lamp vessel and whose ring axis is identical to the longitudinal axis. As a result, the light generated by the axially aligned incandescent filament is predominantly directed in the axial direction, opposite to the sealed end of the lamp vessel. In accordance with one exemplary embodiment of the invention, that section of the lamp vessel which is in the form of a reflector is parabolic or in the form of a free surface, the axis of rotation of the paraboloid or the free surface being arranged in the longitudinal axis, and the apex of the paraboloid or the free surface facing the sealed end of the lamp vessel in order to achieve focused light emission directed in the direction of the longitudinal axis of the lamp vessel. In accordance with another advantageous embodiment of the invention, the lamp vessel is ellipsoidal outside its sealed end, and the section in the form of a reflector essentially surrounds a half-shell of the ellipsoidal lamp vessel. The half-shell in the form of a reflector of the ellipsoid preferably extends from the sealed end of the lamp vessel up to that end of the lamp vessel which is arranged opposite thereto.

As a result, focusing of the light is achieved in the directions transverse to the longitudinal axis of the lamp vessel. The incandescent filament is advantageously completely surrounded by the coated region of the lamp vessel in order to reflect a proportion of the emitted light which is as great as possible in the desired direction. An incandescent filament with dimensions which are as small as possible is advantageously used in order to bring its optical imaging properties more in line with a point light source. The length of the light-emitting part of the incandescent filament is therefore advantageously a maximum of 5 mm and its outer diameter is advantageously a maximum of 3 mm.

The sealed end of the lamp vessel is equipped with a pin-type base or with a separate base. It is advantageously formed as the base in order to ensure dimensions which are as small as possible and to keep the number of components as low as possible.

### III. DESCRIPTION OF THE PREFERRED EXEMPLARY EMBODIMENTS

The invention will be explained in more detail below with reference to a preferred exemplary embodiment. In the drawing:

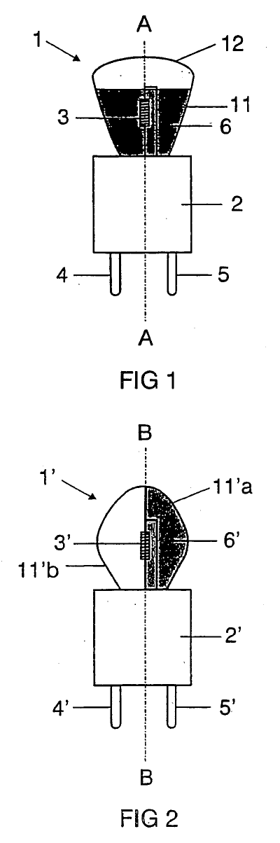

FIG. 1 shows a side view of a first exemplary embodiment of the halogen incandescent lamp according to the invention, in a schematic illustration; and

FIG. 2 shows a side view of a second exemplary embodiment of the halogen incandescent lamp according to the invention, in a schematic illustration.

The first exemplary embodiment of the invention is a low-volt halogen incandescent lamp, which is operated on a voltage of 12 volts and has an electrical power consumption of approximately 20 to 50 watts. This lamp has a vitreous lamp vessel 1 which is sealed at one end. The sealed end 2 of the lamp vessel 1 is in the form of a GY6.35 or else G4 base. The lamp vessel 1 is designed to be axially symmetrical with respect to its longitudinal axis A-A. An axially aligned incandescent filament 3 is arranged within the lamp vessel 1, and its ends are electrically conductively connected to in each case one of the contact pins 4, 5 protruding out of the base. The incandescent filament 3 has an outer diameter of 2.27 mm and its light-emitting coil has a length of 4.19 mm. That section 11 of the lamp vessel 1 which immediately adjoins the sealed end 2 in the form of the base has essentially the shape of a paraboloid of rotation, whose axis of rotation is identical to the longitudinal axis A-A of the lamp vessel 1. The parabolic section 11 of the lamp vessel 1 is provided with a silver layer 6 on its outer surface, which silver layer has a relatively high light reflectance. The remaining radiation is absorbed in an adjoining chromium layer. In order to protect the metallic layers, an SiO₂ layer is applied thereon. That end 12 of the lamp vessel 1 which is remote from the base 2 is in the form of a flattened dome and closes the light exit opening of the parabolic section 11 of the lamp vessel 1. The flattened dome 12 is transparent and is not provided with a coating. The light-emitting part of the incandescent filament 3 is completely surrounded by the parabolic section 11 of the lamp vessel 1, with the result that it is completely hidden in the illustration in FIG. 1 by the coating 6. The incandescent filament 3 has nevertheless been depicted in the schematic illustration in FIG. 1, although it would normally not be visible in the side view in FIG. 1. The maximum transverse dimension of the reflector lamp is only 16 mm. Depending on the wattage, the diameter may be markedly smaller still, down to 6 to 10 mm.

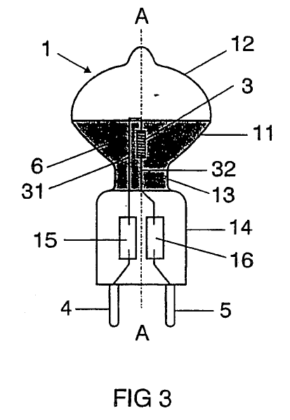

FIG. 3 shows the lamp in accordance with the first exemplary embodiment without the base 2. In this figure, the shape of the lamp vessel 1 is illustrated in a more precise manner in terms of details than in the schematic FIG. 1.

That section 11 of the lamp vessel 1 which is parabolic and is provided with the light-reflective coating 6 is connected to that end of the lamp vessel 1 which is sealed and in the form of a pinch base 14 via a constricted neck region 13, which is likewise provided with the coating according to the invention. The pinch base 14 is arranged in the base 2 once the base has been fitted to the lamp (FIG. 1). The neck region 13 has an inner diameter of 4 mm and an outer diameter of 6 mm. It therefore has smaller transverse dimensions than the parabolic section 11 of the lamp vessel 1. Two power supply wires 31, 32 for the incandescent filament 3 run in the neck region 13, each of which power supply wires is electrically conductively connected to one of the contact pins 4, 5 via a molybdenum foil 15, 16 embedded in the pinch base 14. Details on the incandescent filament 3 and its power supply wires 31, 32 are described in the laid-open specification DE 44 20 607. The light-reflecting coating 6 for this reason extends over the neck region 13 in order to prevent disruptive light emission in this region. Here, too, the coating 6 consists of a silver layer, which is arranged directly on the outer surface of the lamp vessel 1, a chromium layer, which is applied to the silver layer, and an SiO₂ layer, which is arranged on the chromium layer. The silver layer acts as the reflector, while the chromium layer ensures the impermeability to light of the overall layer. The SiO₂ layer serves the purpose of protecting the two metal layers.

The second exemplary embodiment of the invention is a low-volt halogen incandescent lamp, which is operated on a voltage of 12 volts and has an electrical power consumption of approximately 10 to 35 watts. This lamp has a vitreous lamp vessel 1′ which is sealed at one end. The sealed end 2′ of the lamp vessel 1′ is in the form of a G4 base. The lamp vessel 1′ is designed to be axially symmetrical with respect to its longitudinal axis B-B. An axially aligned incandescent filament 3′ is arranged within the lamp vessel 1′, and its ends are electrically conductively connected to in each case one of the contact pins 4′, 5′ protruding out of the base. The incandescent filament 3′ has an outer diameter of 2.17 mm and its light-emitting coil has a length of 3.95 mm. That section of the lamp vessel 1 which directly adjoins the sealed end 2′ in the form of the base essentially has the shape of an ellipsoid of rotation, whose axis of rotation is identical to the longitudinal axis B-B of the lamp vessel 1′. The large half-axis of the ellipsoid is likewise in the longitudinal axis B-B of the lamp vessel 1′. A first half-shell 11′a of the ellipsoidal section of the lamp vessel 1′ is provided with a light-impermeable silver layer 6′ on its outer surface, which silver layer has a high light reflectance. The other half-shell 11′b of the ellipsoidal section of the lamp vessel 1′ is transparent and does not have a coating. The longitudinal axis B-B of the lamp vessel 1′ extends within the plane of separation between the two half-shells 11′a, 11′b. The ratio of the coated to the uncoated part of the surface of the ellipsoidal region of the lamp vessel 1′ can also be set to any desired other value between 40% and 60%, however. In this case, a first reflective layer with rhodium, a second covering layer with nickel and a protective layer consisting of silicon nitride is used as the material of the coating.

The maximum dimensions of the lamp transversely with respect to the longitudinal axis are 16 mm in both exemplary embodiments.

1. A reflector lamp having a transparent lamp vessel (1; 1′) as a single vessel, which defines a lamp axis, and having at least one incandescent filament (3; 3′) arranged within the lamp vessel (1; 1′), characterized in that a section (11; 11′a) of the lamp vessel (1; 1′) is in the form of a reflector contour, a halogen-containing filling being located in the single lamp vessel, and at least the section in the form of a reflector contour being provided on the outside with a reflective coating (6; 6′) consisting of two metals.

2. The reflector lamp as claimed in claim 1, characterized in that the transverse dimension of the lamp vessel at right angles to the lamp axis is at most 30 mm, in particular at most 20 mm.

3. The reflector lamp as claimed in claim 1, characterized in that the reflective coating is a coating (6; 6′), comprising three layers, on the outer surface of the lamp vessel (1; 1′), having a first metallic, highly thermally resistant, reflective layer, a second metallic, highly thermally resistant, covering layer and a nonmetallic protective layer on the two metallic layers.

4. The reflector lamp as claimed in claim 3, characterized in that the first metallic layer consists of silver and/or rhodium.

5. The reflector lamp as claimed in claim 4, characterized in that the layer thickness of the first layer is between 150 and 1200 nm.

6. The reflector lamp as claimed in claim 3, characterized in that the second metallic layer consists of chromium and/or nickel.

7. The reflector lamp as claimed in claim 6, characterized in that the layer thickness of the second layer is between 20 and 500 nm.

8. The reflector lamp as claimed in claim 3, characterized in that the protective layer consists of silicon oxide or silicon nitride.

9. The reflector lamp as claimed in claim 8, characterized in that the layer thickness of the protective layer is between 100 and 800 nm.

10. A halogen incandescent lamp as claimed in claim 1, characterized in that the sealed end (2; 2′) of the lamp vessel (1; 1′) is in the form of a base or bears a base.

11. The halogen incandescent lamp as claimed in claim 1, characterized in that at least the incandescent filament (3; 3′) is completely surrounded by the flat section (11; 11′) of the lamp vessel (1; 1′) which is in the form of a reflector contour.
